(19) United States
(12) Patent Application Publication
(10) Pub. No.: US 2005/0211676 A1
(43) Pub. Date: Sep. 29, 2005

(54) Underwater ceramic electrodes

(76) Inventors: Arthur Metcalfe, San Diego, CA (US); Norbert B. Elsner, San Diego, CA (US); Sakari Mustonen, Uusikyla (FI)

Correspondence Address: JOHN R. ROSS, P.O. Box 2138, DEL MAR, CA, 92014, US

(21) Appl. No.: 10/810,775

(22) Filed: Mar. 25, 2004

(51) Int. Cl. B23K 9/013

(52) U.S. Cl. 219/72; 219/69.1

(57) ABSTRACT

An underwater torch with a metal infiltrated ceramic electrode for cutting and machining. The electrode has a composition with an empirical formula MB_{2-z}+N, wherein 0<z<0.10 and M is selected from the group consisting of Zr, Hf and Ti, wherein N is selected from a group consisting of Cu, Au and Ag and wherein the MB_{2-z} defines a ceramic structure formed with ceramic and defining a volume with void spaces comprising at least 10 percent of the volume of the matrix structure and the N occupies a portion of the void spaces. A preferred electrode material is ceramic matrix of ZrB₂ slightly enriched in Zr that is infiltrated with copper. Preferred methods of making the composition involves at least two step: First, ZrB₂ (which preferably is slightly enriched in Zr) is formed into a ceramic matrix having a density of up to 96 percent. Second, the ceramic matrix is heated in a pool of copper at a vacuum and at an infiltration temperature of about 1700 degrees C. to permit copper from the pool to infiltrate the ceramic matrix. Preferred processes for making the product are similar to the processes described in the '574 patent. Applicants' tests have shown that conductors made for underwater electric discharge cutting provide good results. However, some significant erosion resulted from the flaking off of ceramic powders at the outer surface of the copper infiltrated electrodes when the surface copper melted during the cutting process. To minimize this problem, Applicants have modified the ceramics in the compositions described in the '547 patent. In a preferred embodiment, the metal content in the voids in the ceramic matrix is reduced from at least 70% to between 10% and 30%. In another preferred embodiment ceramic fibers are used in place of ceramic powders. In a third preferred embodiment ceramic wires such as ZrB₂ wires are utilized instead of the ZrB₂ powder. ZrB₂ wires are preferably prepared using a chemical process to convert the Zr wires to ZrB₂ wires. Bundles of the ZrB₂ wires may then be infiltrated with the copper.

This invention relates electrodes and in particular to underwater rotating electrodes with high thermal conductivity and shock resistance.

### BACKGROUND OF THE INVENTION

Cutting and welding of metallic objects underwater is typically done by means of an electric arc established between an electrode and the metallic object. Such metallic objects can be underwater portions of ships and the like, fixed submerged structures such as bridge pilings and especially underwater portions of offshore oil and gas drilling platforms. The most frequently utilized electric-arc cutting process underwater is the oxygen arc process wherein an electric arc is struck between an electrode and the work piece. Simultaneously a stream of oxygen gas is blown into the arc. This cutting process is inaccurate and results in a rough cutting trace. The oxygen gas bubbles reduce the sight of the operator and further the use of oxygen increases the safety hazards.

U.S. Pat. No. 4,842,154 discloses a disc arc cutting apparatus wherein an arc is generated between the periphery of the disc and the work piece. The rotating disc is moved along the work piece which will melt and the rotational movement of the disc will remove melted material from the work piece. The main problem with this technique is related to the safety hazards of the rotating disc. With the disc arc cutting process it is not possible to obtain holes and the like in the work piece. U.S. Pat. No. 5,262,608 describes a device that cuts metals underwater with a spinning cylindrical electrode connected in series to an electric power source. This patent is incorporated herein by reference. Arcing between the metal and the electrode causes the metal to liquefy and this liquid metal is washed away by a jet of water.

Electrodes made from metals such as Copper or Aluminium are unsatisfactory because their surface is melted by the arc and washed away. High melting point metals such as Tungsten are also unsatisfactory because low melting point inter-metallic compounds are formed with the metal being cut that erodes the electrode. Graphite has been found to be a satisfactory electrode material for this process and has been used successfully for cutting thick metal. However, graphite is a relatively soft material and the graphite electrodes eventually become worn due to abrasion by small metal cutting particles retained in cut by the magnetic field. This is especially a problem when cutting ferromagnetic materials such as carbon steel. Furthermore, graphite is a relatively brittle material and is easily broken if the cutting equipment is roughly handled. Other electrode materials are copper-tungsten, steel, zinc-tin alloys, copper, brass, and silver-tungsten. In some applications erosion is not a serious problem; however in other applications, especially where electrodes are expensive, where precision is needed or where replacement of the conductor is difficult or impossible, there is a need to minimize erosion.

One of the Applicants and John Norman were granted a patent (U.S. Pat. No. 5,248,639, issued Sep. 28, 1993) disclosing a ZrB₂ composition which was slightly enriched in Zr. This composition provides enhanced electrical and thermal conductivity and improved thermal shock resistance as compared to the then prior art ZrB₂ conductors. This Applicant along with Anthony Donaldson was granted a patent (U.S. Pat. No. 5,753,574 issued May 19, 1998) which described a process in which hot pressed ZrB₂ powder was infiltrated with copper to produce a ceramic-metal composite electrical conductor. These two patents are hereby incorporated herein by reference. ZrB₂ electrodes have a tendency to erode by spalling. Infiltration with copper substantially reduces the spalling but in some applications further reduction in erosion is desired. What is needed is an electrode with improved erosion resistance and resistance to cracking.

### SUMMARY OF THE INVENTION

The present invention provides an underwater torch with a rotating metal infiltrated ceramic electrode for cutting and machining. The electrode has a composition with an empirical formula MB_{2-z}+N, wherein 0<z<0.10 and M is selected from the group consisting of Zr, Hf and Ti, wherein N is selected from a group consisting of Cu, Au and Ag and wherein the MB_{2-z} defines a ceramic structure formed with ceramic and defining a volume with void spaces comprising at least 10 percent of the volume of the matrix structure and the N occupies a portion of the void spaces. A preferred electrode material is ceramic matrix of ZrB₂ slightly enriched in Zr that is infiltrated with copper. Preferred methods of making the composition involves at least two step: First, ZrB₂ (which preferably is slightly enriched in Zr) is formed into a ceramic matrix having a density of up to 96 percent. Second, the ceramic matrix is heated in a pool of copper at a vacuum and at an infiltration temperature of about 1700 degrees C. to permit copper from the pool to infiltrate the ceramic matrix. Preferred processes for making the product are similar to the processes described in the '574 patent. Applicants tests have shown that conductors made for underwater electric discharge cutting provide good results. However, some significant erosion resulted from the flaking off of ceramic powders at the outer surface of the copper infiltrated electrodes when the surface copper melted during the cutting process. To minimize this problem, Applicants have modified the ceramics in the compositions described in the '547 patent. In a preferred embodiment, the metal content in the voids in the ceramic matrix is reduced from at least 70% to between 10% and 30%. In another preferred embodiment ceramic fibers are used in place of ceramic powders. In a third preferred embodiment ceramic wires such as ZrB₂ wires are utilized instead of the ZrB₂ powder. ZrB₂ wires are preferably prepared using a chemical process to convert the Zr wires to ZrB₂ wires. Bundles of the ZrB₂ wires may then be infiltrated with the copper.

### BRIEF DESCRIPTION OF THE DRAWING

FIG. 1 is an elevation view of an underwater torch cutting and welding apparatus according to the invention.

### DETAILED DESCRIPTION OF PREFERRED EMBODIMENTS

### Torch Cutting and Welding Apparatus

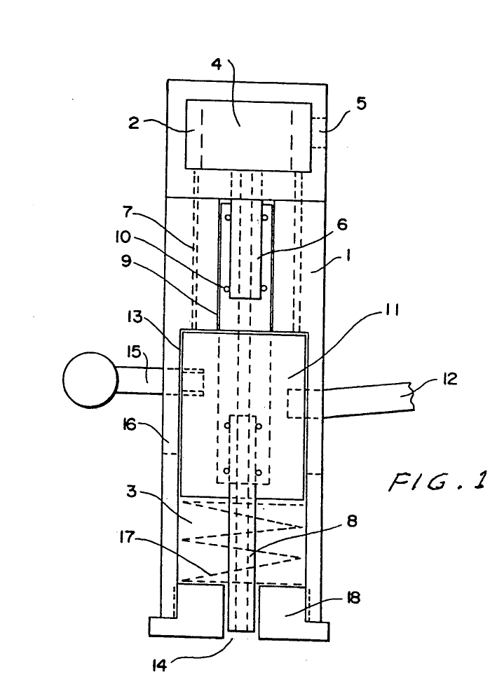

FIG. 1 shows a torch cutting and welding apparatus similar to the device described in the '608 patent. This device comprises a cylindrical body 1 a first chamber 2 and a second chamber 3. A hydraulic motor 4 is disposed in the first chamber 2. The motor 4 comprises a cogwheel or an elliptic cogwheel or a corresponding unit driven by means of pressurized water from an external source (not shown). The first chamber 2 communicates with the external source of pressurized water through an inlet 5. The motor 4 has a shaft 6 connected to the cogwheel, elliptic cogwheel or a corresponding unit. The pressurized water drives the motor 4 to produce in shaft 6 a rotating or a reciprocating motion or a combination of these motions. The first chamber 2 communicates with the second chamber 3 through cooling channels 7 which preferably consist of an annular channel. In this particular embodiment, an elongated electrode 8 is fitted in the second chamber 3. One end of the electrode is connected to the shaft 6 by means of a hollow cylindrical spacer 9. Both the shaft 6 and the electrode 8 are fitted inside the spacer 9 and held in position by means of seal rings 10. The rotating and/or reciprocating motion of the shaft 6 is thus transmitted to the electrode 8. The electrode 8 is partially surrounded by an electrical conductor 11 disposed in the second chamber 3. Electric current is conducted from an external power supply source (not shown) with a cable 12 through the conductor 11 to the electrode 8. The electrode 8 is connected to the negative pole of the power supply source.

The conductor 11 is so dimensioned that there is a space 13 between the outer surface of the conductor and the inner wall of the body. This space constitutes a flow channel 13 for pressurized water. The pressurized water fed into the apparatus drives the motor 4, flows from the first chamber 2 through the cooling channels 7 to the second chamber 3 and along said flow channel 13 to the bottom portion of the second chamber wherein the pressurized water cools the electrode 8 and finally leaves the apparatus through an opening 14 in the body. The pressurized water has several functions. First, it drives the motor 4. Second, it cleans the surface of the conductor 11 and cools the conductor. Third, it cools the electrode 8 and, fourth, it contributes to remove the melt formed by the arc from the work piece.

Further the apparatus comprises a pin 15 attached to the conductor 11 and extending out of the body through an opening 16 in the body wall. Upon pushing the pin 15 inwards the conductor 11 comes into contact with the spacer 9 interconnecting the shaft 6 and the electrode 8. The pin 15 can be moved from a first position wherein the free end of the electrode 8 is inside the body to a second operating position wherein the free end of the electrode 8 is outside the body. The pin 15 is held in the first position by means of a spring 17 positioned in the lower part of the second chamber 3 between the conductor 11 and a nozzle part 18 having an opening 14 for the electrode 8 and the pressurized water. The nozzle part 18 is made of a heat-resistant material such as ceramics. The pin 15 can be locked in the second operating position. This structure enables the cutting to be started for example in the middle of the work piece and, when the electrode is in the non-operating position, protects the electrode from knocks and prevents damages on the diver's hose and other equipments. Body 1 and the motor 4 are made of electrically non-conductive materials, such as plastics.

In devices of this type used for underwater cutting, machining and welding, the choice material for the electrode is typically graphite. However, as described in the Background Section, graphite is a relatively soft material and the graphite electrodes eventually become worn due to abrasion by small metal cutting particles retained in cut by the magnetic field. This is especially a problem when cutting ferromagnetic materials such as carbon steel. Furthermore, graphite is a relatively brittle material and is easily broken if the cutting equipment is roughly handling.

### Metal Infiltrated Ceramic Electrodes

Preferred high temperature thermal shock resistant metal infiltrated ceramic electrodes for underwater cutting, machining and welding as a replacement for graphite electrodes are described below:

### Ceramic Matrix Made from ZrB₂ Powders

In a first preferred embodiment Applicants have made and tested underwater rotating electrodes using the processes described in U.S. Pat. No. 5,248,639. These electrodes produced very good results superior to the prior art graphite electrodes. However, the electrodes experienced significant erosion resulting from the flaking off of ceramic powders at the outer surface of the copper infiltrated electrodes when the supporting copper melted during the cutting process. Applicants suspect that melting and/or evaporation of the copper weakens the retention of the ZrB₂ grains and that that are then lost by mechanical action and/or by chemical action. By mechanical action, Applicants mean pressure pulses resulting from collapsing of steam bubbles similar to cavitations in steam turbines. By chemical action, they mean attack (corrosion) by steam, iron vapor, iron oxide and other reactions. To minimize this problem, Applicants have modified the ceramics in the compositions described in the '547 patent.

### Ceramic Parts

Ceramic Fibers

A preferred technique to improve electrode performance is to substitute ceramic fibers for the ceramic powders in the '574 patent discussed in the Background Section. Applicants accomplish this by changing from a “powder metallurgical” structure to a “fiber metallurgical” structure. The ZrB₂ grains may be elongated in the length direction of an electrode, the radial direction, random or any other orientation. With this approach, the copper content would not be as critical in such material as in the current material. The reason is that the copper would evaporate near the arcing surface yet the ZrB₂ would be slow to follow. The local loss of copper would not be as important because the high electrical conductivity of our ZrB₂ will enable the ZrB₂ to carry the current by itself.

A batch of ZrB₂ fibers plus 1 percent excess of Zr (in accordance with the teachings of U.S. Pat. No. 5,248,639 should be vacuum hot pressed at 2150 degrees C. and 500 psi for a period of 1/2 hours to produce an equal to or greater than 68 percent dense sintered structure that is strong and could endure rugged handling. The structure is then placed in a molten copper bath at 1704 degrees C. and under vacuum for a period of 4 hours where the copper is permitted to infiltrate into the ZrB₂ structure. The resulting composition is a structure comprised of a ZrB₂ matrix with Cu infiltrated within the matrix with the Cu comprising about 32 percent by weight of the composite. The electrodes in this embodiment are rod shaped with a 1.27 cm diameter with a hemispherical tip.

When the ZrB₂ is hot pressed in accordance with the above described procedure, it is not necessary to pressurize the Cu to force it into the matrix. It is preferred that both the hot pressing step and the infiltration step be in a vacuum so the formation of surface oxides are minimized and are removed via the formation of volatile boron oxides. (If, after the porous ZrB₂ sintered structure is formed, the structure is removed from the graphite die in air, oxides will reform on the outer surface and on some of the surfaces of the voids that are open to the atmosphere. If this happens the surface of the structure and the walls of the internal voids in the structure should be re-cleaned via the use of vacuum heating and formation of volatile boron oxides.) Liquid Cu will then wet the ZrB₂ and the Cu will readily infiltrate the ZrB₂ matrix.

Bottle Brush

Another preferred embodiment of the present invention utilizes ceramic wires. The type of structure preferably would resemble a dense “bottle brush” made of ZrB₂ wires and infiltrated with Cu. The wires in the brush would be radial and initially pure Zr. Since ZrB₂ is not ductile, they would be boronized after the brush is fabricated, converting them to ZrB₂. The boronizing process would consist of a pack cementation process. The fabricated wire brush is held in a boron powder container and a gas such as chlorine or iodine is used to transfer the boron to the Zr via the formation of B Cl₂ which is then reduced by the Zr to form ZrB₂. The Cl₂ returns to the B to repeat the process. After boronizing, the Cu infiltration will be performed similar to infiltrating the powder metallurgy specimens previously fabricated and discussed in the '574 patent. Using this approach, electrodes of any diameter and any length could be fabricated.

### Test Results

As indicated above, tests show that MB_{2-z}—Cu electrodes used for electrical discharge machining last much longer than graphite electrodes and much longer than copper electrodes. The tests also indicate that the copper infiltration reduces by an order of magnitude the spalling experienced with un-infiltrated MB₂₋ₓ. With un-infiltrated MB_{2-z}, Applicants' suspect that very tiny (with dimensions of a few microns), very hot (in excess of the vaporization temperature of copper which is 2572 degrees C.) hot spots develop at the surface of the electrode during the electrical pulses. The pulse duration is typically a few microseconds (from about 1 microsecond to 75 microseconds) and the pause time (the time between pulses) is typically about 100 microseconds to a few hundred microseconds. Applicants believe these tiny hotspots stress the material causing spalling. The spalling shows up as tiny craters a few microns across on the surface of the electrodes. On the other hand, when copper is present in the matrix in sufficient quantity, the copper absorbs a substantial portion of the energy of the pulse. As the temperature of the copper at a tiny hot spot reaches 1083 degrees C., the copper begins to melt and the phase change absorbs heat energy from the hot spot and retards the temperature rise at the spot. If additional heat continues to be added at the spot, the temperature at the spot may continue to rise until the vaporizing temperature of copper cools the matrix. The maximum temperature the copper can reach is 2572 degrees C. which is the boiling point of copper. Some of the copper at the electrode surface may vaporize which absorbs additional energy from the hot spot retarding further temperature rise at the spot. The hot spot very quickly cools after the end of the pulse and our calculations indicate that the temperature of the hot spot cools to substantially below the melting point of copper at the end of the pause time after the pulse. Also, since hot spots are fairly randomly distributed over the surface of the electrode during the machining process the next pulse is unlikely to produce another hot spot at the location of the prior hot spot. Thus, the copper acts as a heat sink absorbing hot spot energy to reduce the temperature of the hot spot during pulses so as to allow the energy in the hot spot to be dissipated into the surrounding volume of the electrode. The phase changes (solid to liquid or gas) absorb a substantial portion of the pulse energy which is dissipated within the outer surface of the electrode so that spalling of the ZrB₂ is greatly minimized.

This theory may explain why it seems to be very important to first create a solid matrix of MB_{2-z} and then infiltrate the Cu. For if Cu atoms were a part of the basic matrix the matrix could fail if the Cu melted or vaporized, whereas if the Cu is merely an infiltrator, its melting or vaporization should not substantially affect the matrix structure. Further discussion of the advantages of a matrix structure for electrode material, see the Donaldson dissertation referenced above.

### Applications

This metal infiltrated high temperature ceramic conductor as described above will have many uses. These include: electrodes for electrical discharge machining, spot welding electrodes, thermal bonding electrodes, pulse power electrodes such as those used to break down pollutants like NOₓ and SOₓ, electrodes for arc jet engines and plasma spray guns.

### Examples OF ZRB₂—CU Production

2150 Degrees C.-500 PSI Hot Pressing

ZrB₂ powder was commercially procured from Cerac, located in Milwaukee, Wis. The Cerac grade of this powder was Z 1031 and the p articular batch was 57293-C-1. This powder was very slightly enriched in Zr, Applicants estimate that the composition should be ZrB₂₋ₓ, where x is about 0.07. Applicant's studies have shown that ZrB₂ should be slightly enriched with Zr to obtain lower resistivity ZrB₂.

The powder was loaded in a graphite die, approximately one inch in diameter that contained a Graphoil liner (about 0.002 inch thick). Graphite plungers contained the ZrB₂ powder in the die. The graphite die and plunger assembly was placed in a vacuum hot press and the system evacuated to less than 9.times.10-4 Torr. A compressive load of 500 pounds was placed on the plungers. The die assembly was heated under dynamic vacuum to 2150 degrees C. for 1/2 hour at this same 500 pound load. The die assembly was then allowed to cool to room temperature in an inert gas. The diameter of the finished sample was 1.75 inches, had a length of 1.21 inches and weighed 75.268 grams and its electrical resistivity was 14 to 15 micro-ohms-cm. This specimen was cut in half yielding two cylinders. The density of the cylinder was determined to be 4.16 grams/cc which is about 68 percent of the maximum density of ZrB₂.

One of the ZrB₂ cylinders was placed in a graphite boat with chunks of Cu placed around the ZrB₂. The assembly was placed in a graphite container with a lid to minimize Cu loss due to vaporization. The graphite container was placed in the same vacuum furnace referred to above and the system similarly evacuated. The assembly was heated in vacuum to 1700 degrees C. and held 4 hours. The melted Cu infiltrated the ZrB₂ cylinder by capillary action so that all but a very small percentages of voids in the cylinder were filled with copper as determined by a subsequent density determination and metalographic examination. The density after infiltration had risen to 6.85 grams/cc and the resistivity had decreased to 3.77 micro-ohms-cm.

### 1760 and 2000 Degree Hot Pressing Temperatures

Electrodes were produce using the process described above but with sintering temperatures of 1760 degrees C. and 2000 degrees C., and upon examination the ZrB₂ matrix appeared to be weaker and the copper did not infiltrate the matrix nearly as well.

### Procedure to Assure Slight Excess Zr

Applicants have discovered that the stoichiometry of commercially available ZrB₂ powder can vary substantially. Applicants have determined a simple method of checking, and correcting if necessary, the stoichiometry. A shortage of Zr will cause a ZrB₂ puck to exhibit high electrical resistance. The procedure is to hot press a sample of the material at a high pressure of about 7,000 psi and a temperature of about 2150 degrees C. After pressing the electrical resistance of the puck is checked. If the ZrB₂ puck has acceptable stoichiometry, the resistivity will be about 5 micro-ohms-cm. If it is deficient in Zr the resistance could be as high as 10 micro-ohms-cm or higher. If the resistivity is too high, a small quantity of ZrH₂ is added to the powder. (ZrH2 is preferred over elemental Zr because elemental Zr oxidizes readily.) Another sample puck is then made at 7,000 psi and the resistivity checked again and the procedure is repeated until good values of resistivity are obtained. Hot pressing at 7,000 psi produces pucks with densities of almost 100 percent. When the right stoichiometry is obtained then electrodes are hot pressed at 500 psi. At 500 psi the density is only about 68 percent as stated above which allows space in the ZrB₂ matrix for the Cu infiltration. Excess Zr is also useful for promoting wetting of the ZrB₂ with copper in particular when oxide film surfaces remain on the ZrB₂ surfaces.

### Hot Pressing Range Discussion

Applicants' experiments show that a sintering temperature of 2150 degrees C. for 1/2 hour produces good electrodes. If the temperature is too high or if it is maintained for too long of a period of time, the structure will further densify, many of the pores will become closed and Cu will not be able to infiltrate. If the temperature is too low or the time too short the matrix will be weaker and the matrix could collapse before or during the attempt to infiltrate the Cu. From the above discussion, Applicants recommend a sintering temperature of 2150 degrees C. for 1/2 hour or higher temperature for shorter duration or lower temperatures with longer duration. The highest recommended temperature is 2315 degrees C. for only a few minutes and the lowest temperature recommended would be 1870 degrees for several hours. An advantage of processing at higher temperatures is that boron oxides are more volatile at the higher temperatures and are therefore more likely to be removed.

### Infiltration Range Discussion

Applicants' best sample was obtained with a four hour Cu infiltration time at a temperature of 1700 degrees C. At a higher temperature the infiltration time could be shortened since, in general a higher temperature increases the infiltration rate; however, higher temperature also increases the solubility of ZrB₂ in Cu. Thus, as the Cu infiltration temperature is increased above 1700 degrees C., the ZrB₂ structure can be weakened or it could collapse. Lower temperature (below 1700 degrees C.) is also an option, but Cu may experience poor wetting in some sections due to residual oxides on the ZrB₂ surfaces. Longer infiltration times will to some extent compensate for the reduced wetting. Longer infiltration times gives the oxides additional time to vaporize allowing the Cu to infiltrate further. Summarizing, recommended infiltration times and temperatures are four hours at 1700 degrees C., with a range of about 1540 degrees C. for about 7 hours to 1930 degrees C. for about 1/2 hour.

### Infiltration with Silver, Gold or Aluminum

In addition to Copper, the ZrB₂ matrix can be infiltrated with silver and gold. Silver and gold have melting temperatures and vaporization temperatures and wetting and conduction properties similar to copper. Therefore, these metals can be infiltrated into ZrB₂ like copper and should have the same general effect as the copper in preventing spalling, and in some applications gold or silver could be preferred. The big disadvantage of silver and gold is that these materials are much more expensive than copper. Recommended infiltration temperatures would be about 1700 degrees C. for gold or for silver with a four hour infiltration time. Ranges like those discussed above could be used. Aluminum can be infiltrated and seems to reduce or remove the boron oxide surface layers.

### TiB₂ and HfB₂

Titanium diboride and Hafnium diboride can also be hot pressed into a matrix structure and then infiltrated with copper, gold or silver to produce an electrode resistant to spalling. The recommended process is similar to that described in detail above except the sintering temperatures should be adjusted downward for titanium and upward for hafnium taking into account their differences in melting points. A sintering temperature of 2200 degrees C. is recommended for HfB₂ and a sintering temperature of 2050 degrees C. is recommended for TiB₂.

While the above description contains many specificities, the reader should not construe these as limitations on the scope of the invention, but merely as exemplifications of preferred embodiments thereof. Those skilled in the art will envision many other possible variations that are within its scope. For example as discussed in U.S. Pat. No. 5,248,639, Ti and or Hf could replace a portion or all of the Zr in the ZrB₂ starting powder. There are other well known methods of producing porous ceramic structures which can be infiltrated with copper, silver and gold. For example, ZrB₂ powder can be blended with an organic binder and injection molded to the desired dimensions. The injection molded part can then be heated (at about 500 degrees C.) in a vacuum or inert gas furnace to slowly remove the binder. The part can then be fired at about 2100 degrees C. to obtain a density of about 68 percent or higher and remove surface oxides. ZrB₂ powder can also be fabricated into a desired shape by cold pressing and sintering. The powder is first cold pressed into the desired shape (with or without a binder). The cold pressed component is then sintered at about 2100 degrees C. in a vacuum to obtain a 68 percent density and to remove the surface oxides. A third alternative approach is a to form the 68 percent porous ZrB₂ structure by plasma spraying the ZrB₂ powder on a removable substrate. The ZrB₂ is then heated to 2100 degrees C. to remove the surface oxides. A fourth approach is to form the ZrB₂ parts by slip casting. After the slip cast parts are dried in air they are then fired at about 2100 degrees C. in vacuum to obtain about 68 percent density and remove the surface oxides. Components fabricated by these processes can be very near the net shape and low in cost to produce. With the above techniques for forming the ZrB₂ porous shapes, the same Cu infiltration process described above can be used for fabricating the ZrB₂—Cu composites. Another variation would be to decrease the work function of the ZrB₂ by selected rare earth boride or other metal additions. The electrodes could have many shapes in addition to rod shapes and disc shapes. Accordingly, the reader is requested to determine the scope of the invention by the appended claims and their legal equivalents and not by the examples which have been given.

1. An underwater torch for cutting and welding comprising:
A) a motor having a movable shift;
B) an electrode which is connected to said shaft, said electrode being comprised of composition with an empirical formula MB_{2-z}+N, wherein 0<z<0.10 and M is selected from the group consisting of Zr, Hf and Ti, wherein N is selected from a group consisting of Cu, Au and Ag and wherein the MB_{2-z} defines a ceramic structure formed with ceramic and defining a volume with void spaces comprising at least 10 percent of the volume of the matrix structure and the N occupies a portion of the void spaces.
C) an electrically conductive means fitted around at least a portion of said electrode and through which conductive means electric current is conducted from an external power supply source to said electrode.

2. The torch as in claim 1 wherein the MB_{2-z} portion of the composition comprises elongated components.

3. The torch as in claim 2 wherein said elongated components are fibers.

4. The torch as in claim 2 wherein said elongated components are wire fragments.

5. The torch as in claim 2 wherein said elongated components are elongated grains.

6. The torch as in claim 2 wherein said elongated components are oriented radially.

7. The torch as in claim 2 wherein said elongated components are oriented randomly.

8. The torch as in claim 1 wherein M is Zr.

9. The torch as in claim 1 wherein M includes Zr and Hf.

10. The torch as in claim 1 wherein M includes Zr and Ti.

11. The torch as in claim 1 wherein M is Hf.

12. The torch as in claim 1 wherein M is Ti.

13. The torch as in claim 1 wherein z is about 0.07.

14. The torch as in claim 1 wherein N is copper.

15. The torch as in claim 1 wherein said void spaces comprise at least 30 percent of the volume of said matrix.

16. The torch as in claim 1 wherein said movable shaft is a rotating shaft.

17. The torch as in claim 16 wherein said electrode is rod shaped.

18. The torch as in claim 16 wherein said electrode is disc shaped.

19. The torch as in claim 1 wherein said movable shaft is a reciprocating shaft.

20. The torch as in claim 13, wherein said void spaces comprise about 32 percent of the volume of said matrix.

21. The torch as in claim 14 wherein said void spaces comprise at least 32 percent of the volume of said matrix and the Cu occupies at least 95 percent of the void space.

22. The torch as in claim 1 wherein said electrode is a consumable electrode.

23. An apparatus for underwater torch cutting and welding comprising a body having at least a first chamber and a second chamber; a hydraulic motor fitted in said first chamber and communicating with an external source of a pressurized liquid medium, said motor having a movable shaft; an electrode which is connected to said shaft, and at least a portion of said electrode being adapted to extend out of said body through an opening in said body; electrically conductive means fitted in said second chamber around at least a portion of said electrode and through which conductive means electric current is conducted from an external power supply source to said electrode, said apparatus comprising means for cutting into a work piece by means of said elongated electrode and for moving said electrode in a desired path along the work piece to make a cutting of a desired shape; and means for communicating said first chamber with said external source of a pressurized liquid medium; wherein said electrode is comprised of composition with an empirical formula MB_{2-z}+N, wherein 0<z<0.10 and M is selected from the group consisting of Zr, Hf and Ti, wherein N is selected from a group consisting of Cu, Au and Ag and wherein the MB_{2-z} defines a ceramic structure formed with ceramic and defining a volume with void spaces comprising at least 10 percent of the volume of the matrix structure and the N occupies a portion of the void spaces.

24. An apparatus as claimed in claim 23 further comprising means defining a passageway from said first chamber through said second chamber and through said opening in said body through which said electrode also extends, whereby said liquid medium is received into said first chamber for powering said hydraulic motor and is communicated along said electrode and discharged from said apparatus through said opening in said body through which said electrode extends.

25. A method of underwater torch cutting by means of an apparatus comprising:
A) a motor having a movable shaft;
B) an elongated electrode, comprised of composition with an empirical formula MB_{2-z}+N, wherein 0<z<0.10 and M is selected from the group consisting of Zr, Hf and Ti, wherein N is selected from a group consisting of Cu, Au and Ag and wherein the MB_{2-z} defines a ceramic structure formed with ceramic and defining a volume with void spaces comprising at least 10 percent of the volume of the matrix structure and the N occupies a portion of the void spaces one end of which is connected to said shaft,
C) an electrically conductive means fitted in said second chamber around at least a portion of said electrode and through which conductive means electric current is conducted from an external power supply source to said electrode, the method comprising the steps of:
a) connecting said conductive means to said external power supply source; and
b) cutting into a work piece by means of said elongated electrode and moving said electrode in a desired path along the work piece to make a cutting of a desired shape.
